(19) United States
(12) Patent Application Publication
(10) Pub. No.: US 2021/0374889 A1
(43) Pub. Date: Dec. 2, 2021

(54) System and Method for Managing Educational Accommodations for Students

(71) Applicant: Monte Keith Regester, II, Athens, TX (US)

(72) Inventor: Monte Keith Regester, II, Athens, TX (US)

(21) Appl. No.: 17/332,918

(22) Filed: May 27, 2021

Related U.S. Application Data
(60) Provisional application No. 63/030,700, filed on May 27, 2020.

(51) Int. Cl. G06Q 50/20; G06Q 30/00; G06F 3/14

(52) U.S. Cl. CPC G06Q 50/205; G06F 3/14; G06Q 30/018

(57) ABSTRACT

A system and a method for managing educational accommodations for students relate to a method for recording and reviewing the implementation of special accommodations for students by educational faculty. A tiered top-down view spanning from high-level district administrators to individual teachers is provided in real-time to ensure compliance at every level of accountability. This arrangement enables principals to monitor teachers, superintendents to monitor principals, and so on as necessary. Required teacher activities are monitored for each student dependent on the student's classification of special education services rendered via their individualized education plan (IEP). The educator inputs comments and verifies that the accommodations are being provided in that classroom for each student on a daily and weekly basis. The administrators are able to view the actions done by the educator within the application of the present invention to ensure compliance across all areas of the school district.

The current application claims a priority to the U.S. Provisional Patent application Ser. No. 63/030,700 filed on May 27, 2020.

### FIELD OF THE INVENTION

The present invention generally relates to data management. More specifically, the system and method for managing educational accommodations for students relates to recording and reviewing the implementation of special accommodations for students by educational faculty.

### BACKGROUND OF THE INVENTION

The education industry is constantly adapting to changing standards. Educational standards are developed at the national, state, and municipal levels to cater to the abilities of the majority; however, such an approach leaves many students in need of additional support to achieve academic goals. These students have been generally divided by need into one of five major special populations in school districts: Title IX 504, special education (SPED), behavioral intervention plan (BIP), English-language learners (ELL), and response to intervention (RTI). Each category has its own set of potentially-necessary accommodations, which can be customized at the classroom level according to the needs of each student. The available programs and features of each accommodation type are dynamic, requiring educators to stay up-to-date with the latest teaching paradigms, technologies, and practices.

Unfortunately, existing techniques for facilitating tracking of the implementation of accommodations on students are deficient with regard to several aspects. For instance, current technologies do not provide an analysis of the activities of teachers against the accommodation of students. Furthermore, current technologies do not ensure compliance for fulfilling the accommodation of the students. Such technologies therefore cannot be used effectively to guarantee quality of education or as evidence to protect educators from legal liability. Therefore, there is a need for improved systems and methods for facilitating tracking of accommodation implementation on students that may overcome one or more of the above-mentioned problems and/or limitations.

The present disclosure addresses these issues. An online software tracks many special populations in public education. A tiered top-down view spanning from high-level district administrators to individual teachers is provided in real-time to ensure compliance at every level of accountability. This arrangement enables principals to monitor teachers, superintendents to monitor principals, and so on as necessary. Required teacher activities are monitored for each student dependent on the student's classification of special education services rendered via their individualized education plan (IEP). The educator inputs comments and verifies that the accommodations are being provided in that classroom for each student on a daily and weekly basis. The online collaborative software is used to view confidential student accommodation information. Educators then analyze those accommodations against actual actions taking place in the classroom. In some cases, students may be associated with multiple populations, and therefore may require more accommodation validation. The administrators are able to view the actions done by the educator within the application of the present invention to ensure compliance across all areas of the school district.

### BRIEF DESCRIPTION OF THE DRAWINGS

FIG. 1 is a block diagram illustrating the system of the present invention.

FIG. 2 is a flowchart illustrating the overall process of the present invention.

FIG. 3 is a continuation of FIG. 2.

FIG. 4 is a flowchart illustrating a subprocess of managing dated compliance entries.

FIG. 5 is a flowchart illustrating a subprocess of providing administrative access to student accounts.

FIG. 6 is a flowchart illustrating a subprocess of providing administrative access to education accommodations.

FIG. 7 is a flowchart illustrating a subprocess of providing administrative access to dated compliance entries.

FIG. 8 is a flowchart illustrating a subprocess of forming educational groups.

FIG. 9 is a flowchart illustrating a subprocess of reassigning educators to new educational groups.

FIG. 10 is a flowchart illustrating a subprocess of reassigning students to new educational groups.

FIG. 11 is a flowchart illustrating a subprocess of adding educational accommodations to student profiles.

FIG. 12 is a flowchart illustrating a subprocess of verifying dated compliance entries.

### DETAILED DESCRIPTION OF THE INVENTION

All illustrations of the drawings are for the purpose of describing selected versions of the present invention and are not intended to limit the scope of the present invention.

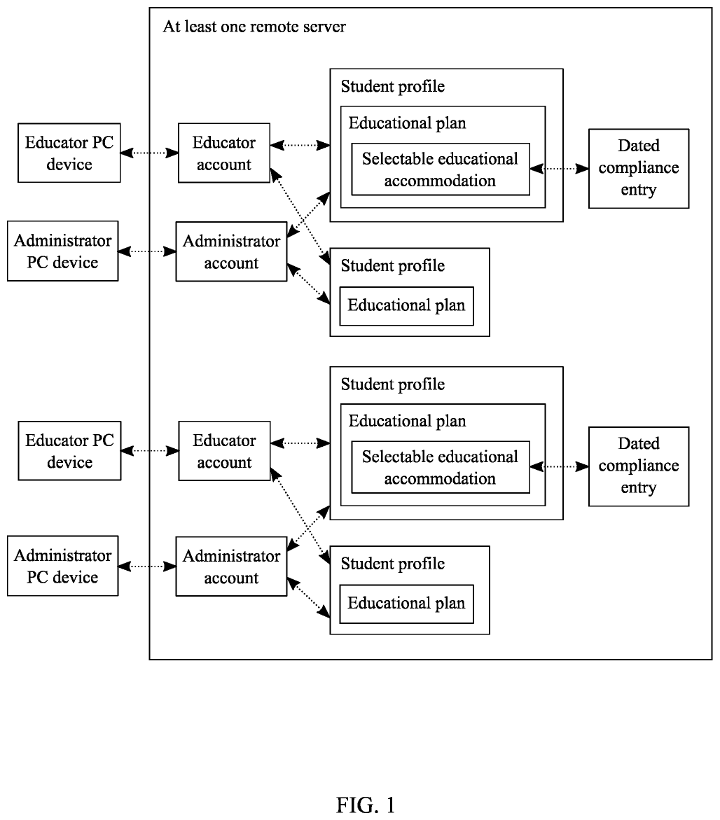

The present invention is a system and method for managing educational accommodations for students that provides a system for tracking implementation of necessary academic accommodations according to the needs of each student. The present invention accomplishes this by providing an interface through which educators can confirm and review completion of accommodation implementation. The system of the present invention includes a plurality of educator accounts managed by at least one remote server, wherein each educator account is associated with a corresponding educator personal computing (PC) device (Step A), as represented in FIG. 1. The plurality of educator accounts relates to the set of accounts for teachers who interact with students to apply accommodations. The remote server is a wireless system for managing, manipulating, and storing data that enables and manages communication between authorized accounts and stored material. The corresponding educator PC device denotes any of a variety of electronic devices, including, but not limited to, iPhones, androids, laptops, desktop computers, smart devices, or any other tools capable of allowing each educator account to wirelessly connect to the remote server. The system of the present invention further includes a plurality of student profiles managed by the remote server, wherein the plurality of student profiles is associated with the plurality of educator accounts, and wherein each student profile includes an educational plan (Step B). The plurality of student profiles denotes the set of information corresponding to each student associated with a given classroom, instructor, or other similar educational group. The educational plan relates to the set of student-specific accommodations required for each student profile.

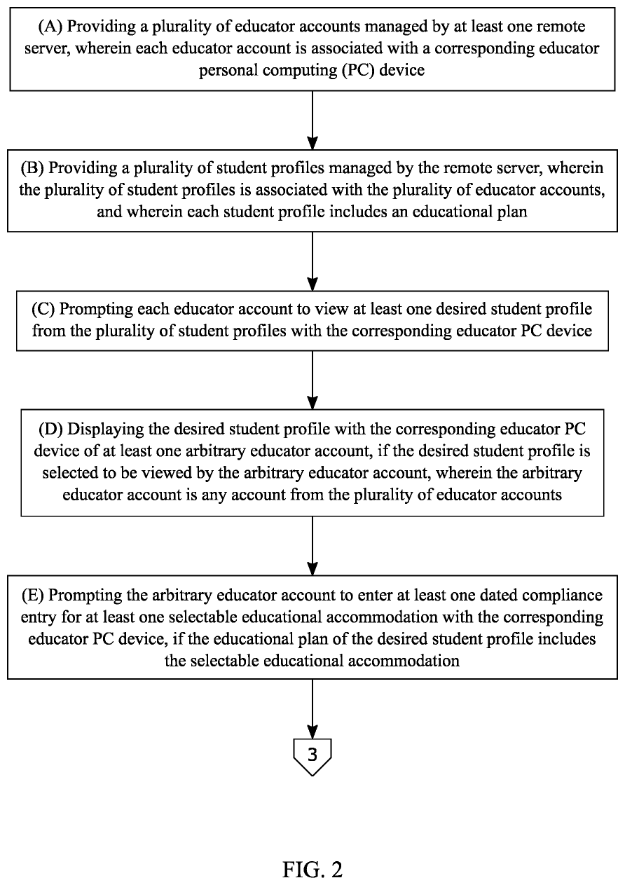

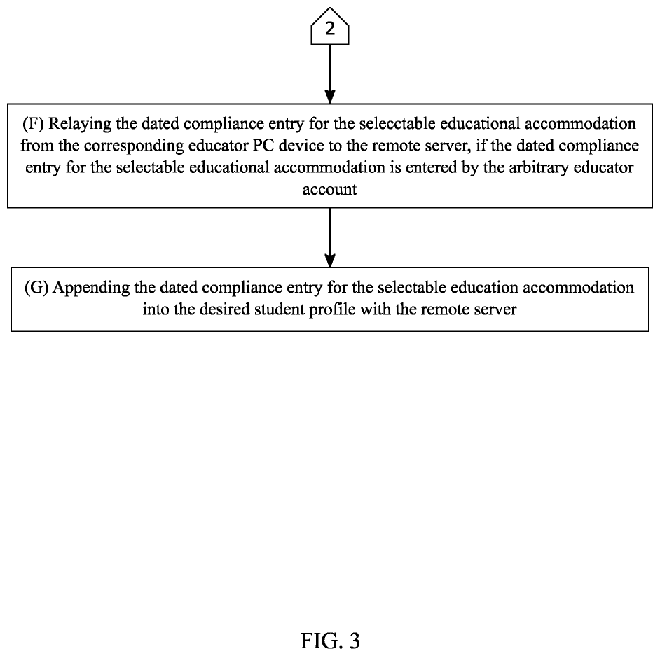

The overall process followed by the method of the present invention allows for effective and efficient organization and management of student accommodations. Each educator account is prompted to view at least one desired student profile from the plurality of student profiles with the corresponding educator PC device (Step C), as represented in FIG. 2. In this way, the educator account may access information about a student of interest. Next, the desired student profile is displayed with the corresponding educator PC device of at least one arbitrary educator account, if the desired student profile is selected to be viewed by the arbitrary educator account, wherein the arbitrary educator account is any account from the plurality of educator accounts (Step D). This arrangement enables the educator account to view and analyze information associated with the desired student profile. Subsequently, the arbitrary educator account is prompted to enter at least one dated compliance entry for at least one selectable educational accommodation with the corresponding educator PC device, if the educational plan of the desired student profile includes the selectable educational accommodation (Step E). The dated compliance entry is an interactive option representing completion or incompletion of a selectable educational accommodation. The selectable educational accommodation is a specific set of guidelines which define the necessary accommodations required for the desired student profile. Entering a dated compliance entry signifies completion of, or progress on, fulfilling a selectable educational accommodation. The dated compliance entry for the selectable educational accommodation is next relayed from the corresponding educator PC device of the arbitrary educator PC device to the remote server, if the dated compliance entry for the selectable educational accommodation is entered by the arbitrary educator account (Step F), as represented in FIG. 3. In this way, records of progress and completion of selectable educational accommodations may be documented as they are completed. Finally, the dated compliance entry for the selectable education accommodation is appended into the desired student profile with the remote server (Step G). Thus, the desired student profile may be tracked with respect to progress on the selectable educational accommodations associated with the desired student profile.

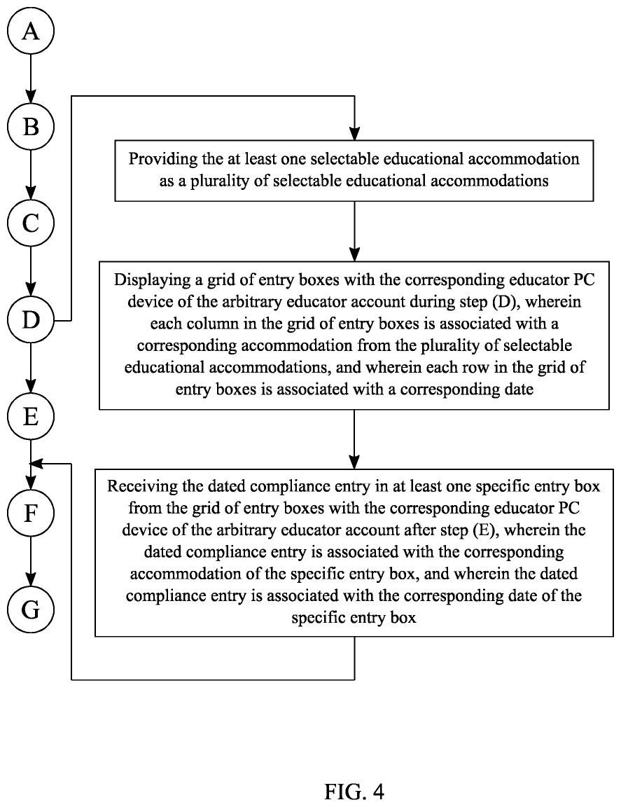

There are many students who may fall into multiple categories of accommodations-requiring groups. To this end, the at one selectable educational accommodation may be provided as a plurality of selectable educational accommodations, as represented in FIG. 4. The plurality of selectable educational accommodations is a set of necessary actions and educational adjustments that must be undertaken in order to provide a given student account with an effective education. A grid of entry boxes is next displayed with the corresponding educator PC device of the arbitrary educator account during Step D, wherein each column in the grid of entry boxes is associated with a corresponding accommodation from the plurality of selectable educational accommodations, and wherein each row in the grid of entry boxes is associated with a corresponding date. The grid of entry boxes provides an intuitive display for the tabular time series data continuously generated by the plurality of selectable educational accommodations. Subsequently, the dated compliance entry is received in at least one specific entry box from the grid of entry boxes with the corresponding educator PC device of the arbitrary educator account after Step E, wherein the dated compliance entry is associated with the corresponding accommodation of the specific entry box, and wherein the dated compliance entry is associated with the corresponding date of the specific entry box. The dated compliance entry may be a checkbox, a selection among radio buttons, a textual input, or a variety of other feedback criteria that communicates progress upon the item within the specific entry box.

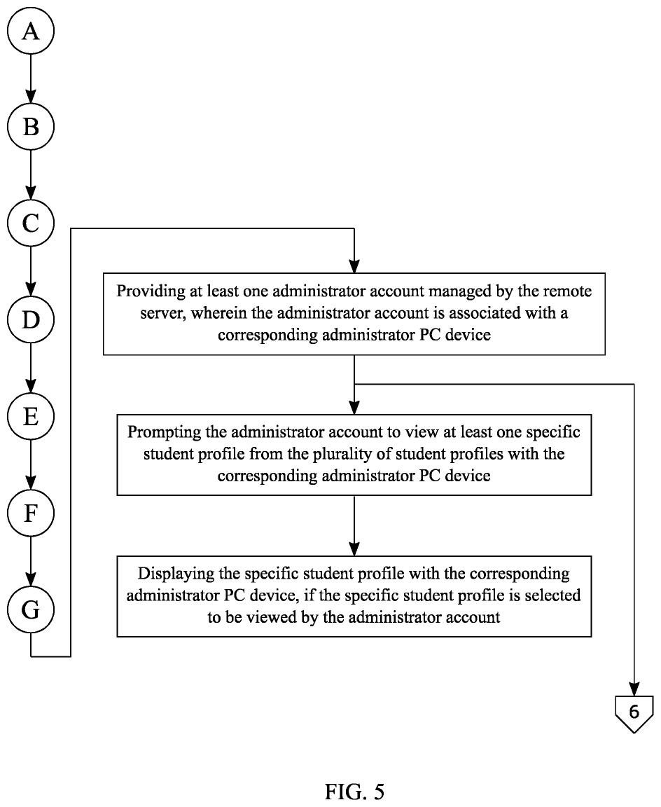

The present invention enables administrators at various levels in the education management chain to access information about each student. To enable this, at least one administrator account managed by the remote server may be provided, wherein the administrator account is associated with a corresponding administrator PC device, as represented in FIG. 5. The administrator account may further belong to a tiered system of administrator accounts, thereby enabling different levels of access as relevant. The corresponding administrator PC device denotes any of a variety of electronic devices, including, but not limited to, iPhones, androids, laptops, desktop computers, smart devices, or any other tools capable of allowing each administrator account to wirelessly connect to the remote server. The administrator account is prompted to view at least one specific student profile from the plurality of student profiles with the corresponding administrator PC device. The administrator account may thus identify and request access to an individual student managed by an educator account of the plurality of educator accounts. The specific student profile is then displayed with the corresponding administrator PC device, if the specific student profile is selected to be viewed by the administrator account. In this way, the administrator account may access and monitor different student profiles.

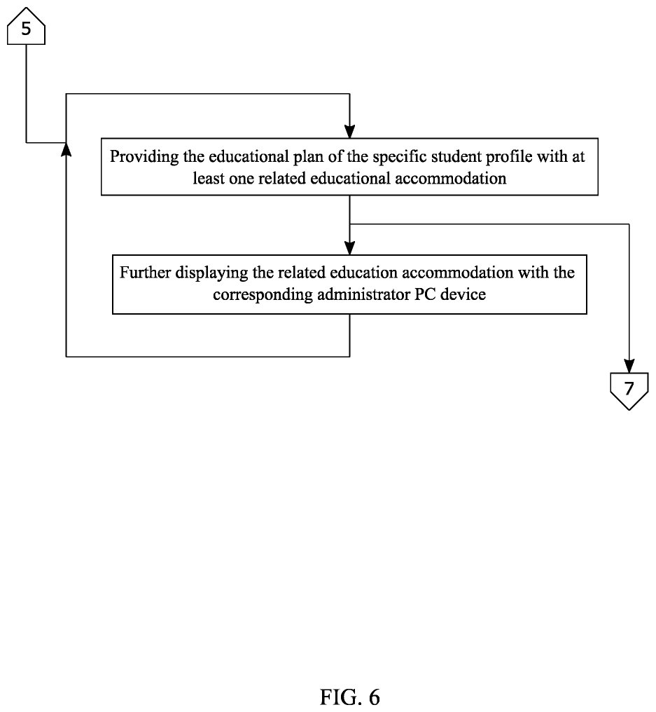

It may further be desirable for the administrator account to view and access the accommodations associated with the specific student profile. To achieve this, the educational plan of the specific student profile may be provided with at least one related educational accommodation, as represented in FIG. 6. The related educational accommodation relates to the accommodations required by the specific student profile. The related education accommodation is further displayed with the corresponding administrator PC device. Thus, the administrator account may view all of the accommodations associated with the specific student profile.

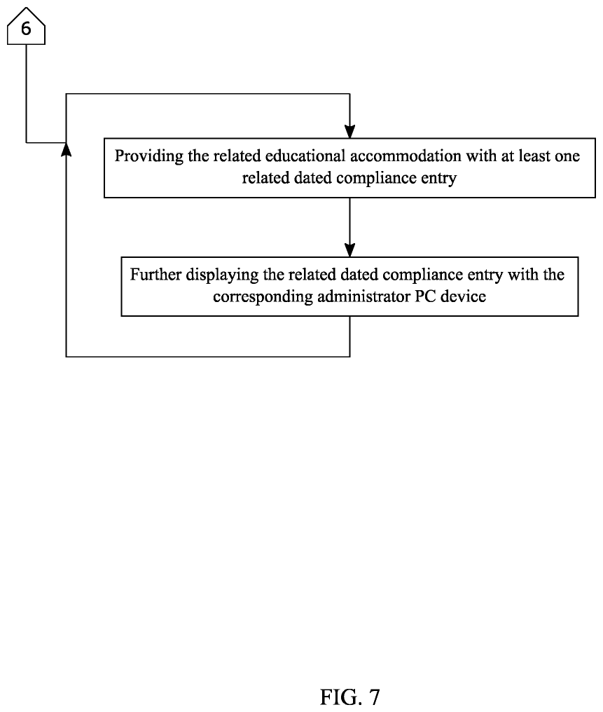

Furthermore, an administrator profile may need to see progress on the achievement of the related educational accommodation. To this end, the related educational accommodation may be provided with at least one related dated compliance entry, as represented in FIG. 7. The related dated compliance entry may be any of a variety of input types capable of indicating full, partial, or non-completion of the related educational accommodation. The related dated compliance entry may then be further displayed with the corresponding administrator PC device. In this way, the administrator account can view feedback about the success rates of educational accommodations.

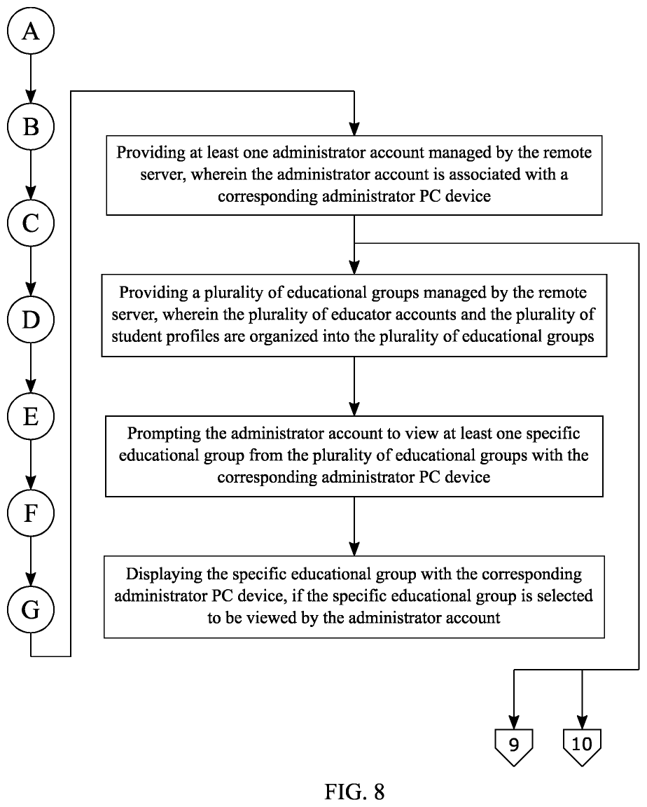

An advantage of the present invention is that a hierarchical organization of accounts may be provided. To enable this, at least one administrator account managed by the remote server may be provided, wherein the administrator account is associated with a corresponding administrator PC device, as represented in FIG. 8. Furthermore, a plurality of educational groups managed by the remote server may also be provided, wherein the plurality of educator accounts and the plurality of student profiles are organized into the plurality of educational groups. In this way, each educator account of the plurality of educator accounts is associated with corresponding student profiles from the plurality of student profiles. The administrator account is then prompted to view at least one specific educational group from the plurality of educational groups with the corresponding administrator PC device. In this way, the administrator account may select from the educational faculty under the jurisdiction of the administrator account. The specific educational group is next displayed with the corresponding administrator PC device, if the specific educational group is selected to be viewed by the administrator account. Thus, the administrator account may view a teacher account and the corresponding plurality of student profiles as desired. Moreover, an educational group may fall into one of several distinct categories. In general, each educational group may be selected from a group consisting of: a class, a school, and a schooling district. This organization mimics a common organizational structure of educational resources.

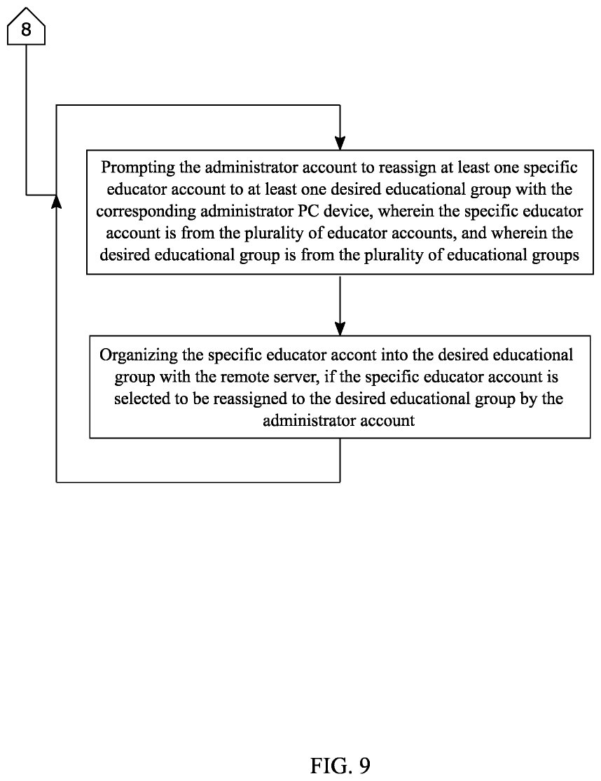

An administrator may wish to reassign educators to different, more appropriate classrooms or educational groups. To provide for this, the administrator account may be prompted to reassign at least one specific educator account to at least one desired educational group with the corresponding administrator PC device, wherein the specific educator account is from the plurality of educator accounts, and wherein the desired educational group is from the plurality of educational groups, as represented in FIG. 9. The administrator account may navigate through options with the corresponding administrator PC device in order to select the appropriate specific educator account and the appropriate desired educational group. The specific educator account is then organized into the desired educational group with the remote server, if the specific educator account is selected to be reassigned to the desired educational group by the administrator account. In this way, the specific educator account is made aware of a change and may respond accordingly without confusion.

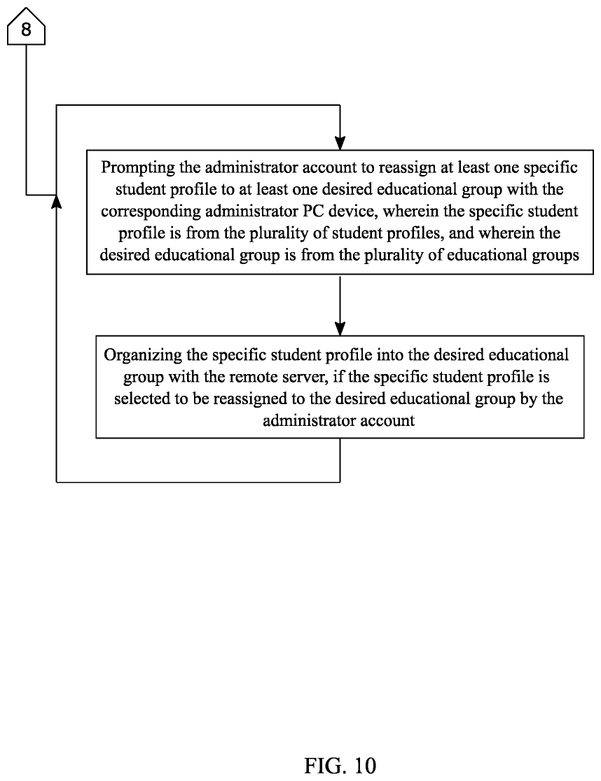

Similarly, it may be advantageous to allow an administrator account to manipulate student profiles into appropriate educational groups. To this end, the administrator account may be prompted to reassign at least one specific student profile to at least one desired educational group with the corresponding administrator PC device, wherein the specific student profile is from the plurality of student profiles, and wherein the desired educational group is from the plurality of educational groups, as represented in FIG. 10. The administrator account may navigate through options with the corresponding administrator PC device in order to select the appropriate specific student profile and the appropriate desired educational group. The specific student profile is then organized into the desired educational group with the remote server, if the specific student profile is selected to be reassigned to the desired educational group by the administrator account. Thus, the specific student profile may be appropriately connected to the appropriate educational group.

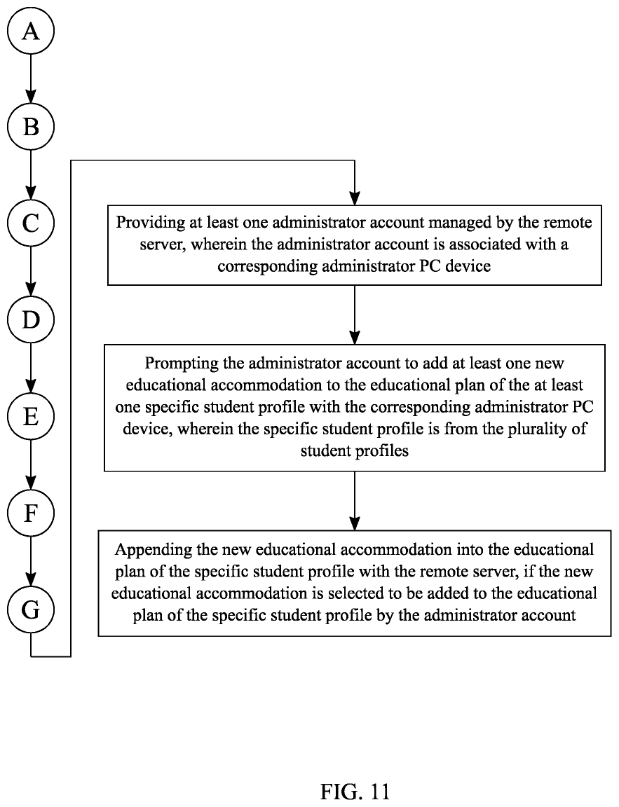

It may be desirable for an administrator account to modify the required accommodations for a given student profile. To allow for this, at least one administrator account managed by the remote server may be provided, wherein the administrator account is associated with a corresponding administrator PC device, as represented in FIG. 11. The administrator account may be prompted to add at least one new educational accommodation to the educational plan of at least one specific student profile with the corresponding administrator PC device, wherein the specific student profile is from the plurality of student profiles. This may be due to changing circumstances for the specific student profile, changes in staff, changing resources, or a variety of other potential reasons. The new educational accommodation is then appended into the educational plan of the specific student profile with the remote server, if the new educational accommodation is selected to be added to the educational plan of the specific student profile by the administrator account. Thus, the new educational accommodation may be provided for the specific student profile.

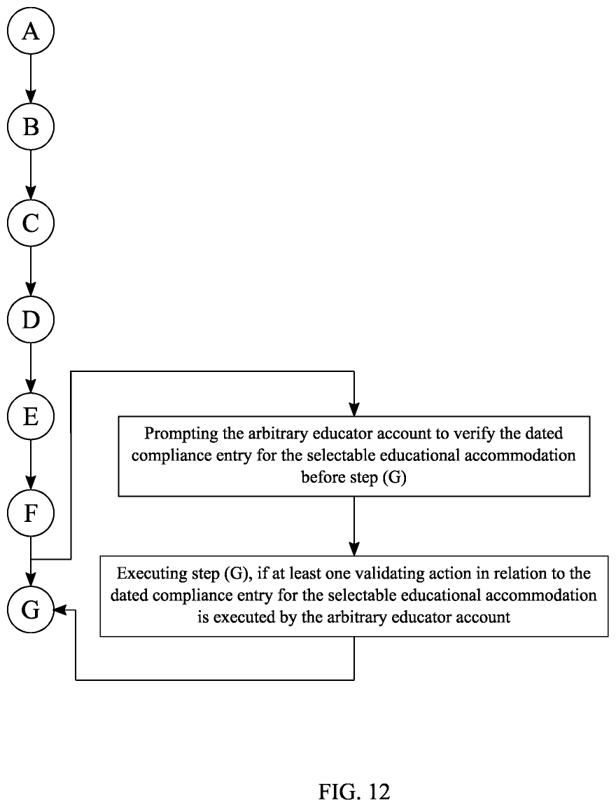

An arbitrary educator account may wish to reaffirm completion of a selectable educational accommodation. To this end, the arbitrary educator account is prompted to verify the dated compliance entry for the selectable educational accommodation before Step G, as represented in FIG. 12. In this way, the arbitrary educator account may review and confirm authenticity of the dated compliance entry. Then Step G is executed, if at least one validating action in relation to the dated compliance entry for the selectable educational accommodation is executed by the arbitrary educator account. In this way, the completion of the dated compliance entry may be confirmed.

### Supplemental Description

The purpose of the present invention, also known as a data accommodation service hub (DASH), is an online software that tracks special populations in public education. The present invention gives a top-down view from the admin to the teacher via real-time viewing to ensure compliance at every level of accountability. The present invention monitors required teacher activities per student dependent on the student's classification of special education services rendered via their Individualized Education Plan (IEP).

The present invention is able to function by utilizing online collaborative software to view confidential student accommodation information. Educators then analyze those accommodations against actual actions taking place in the classroom. The educator inputs comments and verifies that the accommodations are being provided in that classroom for that student, on a daily and weekly basis. This action is repeated across the five major special populations in school districts: (Title IX 504, SPED, BIP, ELL, and RTI). In some cases, students may be associated with multiple populations and therefore require more accommodation validation. The outliers administrators are able to view the actions done by the educator within the DASH application to ensure compliance across all areas of the school district.

The present invention is a software application that includes the following components: super admin (i.e., where the Software as a Service is managed by the owners of the software); customer portal (i.e., where school districts and their users do all of the work); authentication (i.e., login, registration, forgot password); district management (i.e., where the school district (SD) can manage everything below them; campus management (i.e., where SD's set up each school); user management (i.e., setting up teachers and administrators, and assigning access to classes, students, etc.); student management (i.e., create, read, update students); classes management (i.e., setting up the classes, assigning them to teachers, etc.); special population management (i.e., where you would add ESL, etc., and by default, the main ones would be here); accommodations management (i.e., default list plus the ability to add more); holiday/vacation management (i.e., list of SD days off in the system); accommodations tracking (i.e., this is where the teachers would track their status with accommodations per student); reports (i.e., reports showing the teacher activities around accommodations); notifications/reminders (i.e., notifications if tracking has not been done for a specific day/student(s)); logins for users; dashboard showing classroom students enrolled in that educator's class; special education accommodations of each student; viewing of all students and their information; comment button and verification boxes validating actions taken; administration viewing of all faculty and staff individual accounts; and school calendar and current date built-in.

The components of the present invention are put together in the following way: students are compiled based upon association of special education population category, wherein there are five special education categories; teacher views students and selects student of choice to view accommodations; student name is on the top of the screen, all current accommodations are beneath this name; to the right of the accommodations, the current date is present; directly below the current date, the school calendar is populated vertically, showing all days of accommodation opportunity; teacher inputs a “Yes” directly underneath the accommodation that was provided to that student, directly across from the current day of the week in which it was provided; administration (principals, superintendents, etc.) will be able to view all actions of the educators via a super admin portal.

Further, the accommodations may include State and Federally mandated modifications of instruction assigned to students under the age of 19 years of age. Accommodations include “check for understanding”, “repeated review”, and “oral administration of questions and answers.”

Further, DASH is a software that helps teachers and administration simplify the process of tracking accommodation implementation in the classroom.

Further, the “504” is the 504 Plan is a plan developed to ensure that a child who has a disability identified under the law and is attending an elementary or secondary educational institution receives accommodations that will ensure their academic success and access to the learning environment.

Further, SPED (Special Education) is the practice of educating students in a way that addresses their individual differences and needs. Ideally, this process involves the individually planned and systematically monitored arrangement of teaching procedures, adapted equipment and materials, and accessible settings.

Further, BIP (Behavior Intervention Plan) is an improvement plan that lays out how an IEP team will better solve difficult behavior that is inhibiting a child's academic success.

Further, ELL (English-language learners) are students who are unable to communicate fluently or learn effectively in English, who often come from non-English-speaking homes and backgrounds, and who typically require specialized or modified instruction in both the English language and in their academic courses.

Further, RTI (Response to Intervention) is a multi-tier approach to the early identification and support of students with learning and behavior needs. The RTI process begins with high-quality instruction and universal screening of all children in the general education classroom.

Further, IEP is a legal document under United States law that is developed for each public-school child in the U.S. who needs special education. The IEP is created through a specific team of the child's parent and district personnel who are knowledgeable about the child.

Although the invention has been explained in relation to its preferred embodiment, it is to be understood that many other possible modifications and variations can be made without departing from the spirit and scope of the invention as hereinafter claimed.

What is claimed is:

1. A method of managing educational accommodations for students, the method comprises the steps of:
(A) providing a plurality of educator accounts managed by at least one remote server, wherein each educator account is associated with a corresponding educator personal computing (PC) device;
(B) providing a plurality of student profiles managed by the remote server, wherein the plurality of student profiles is associated with the plurality of educator accounts, and wherein each student profile includes an educational plan;
(C) prompting each educator account to view at least one desired student profile from the plurality of student profiles with the corresponding educator PC device;
(D) displaying the desired student profile with the corresponding educator PC device of at least one arbitrary educator account, if the desired student profile is selected to be viewed by the arbitrary educator account, wherein the arbitrary educator account is any account from the plurality of educator accounts;
(E) prompting the arbitrary educator account to enter at least one dated compliance entry for at least one selectable educational accommodation with the corresponding educator PC device, if the educational plan of the desired student profile includes the selectable educational accommodation;
(F) relaying the dated compliance entry for the selectable educational accommodation from the corresponding educator PC device of the arbitrary educator PC device to the remote server, if the dated compliance entry for the selectable educational accommodation is entered by the arbitrary educator account; and
(G) appending the dated compliance entry for the selectable education accommodation into the desired student profile with the remote server.

2. The method of managing educational accommodations for students, the method as claimed in claim 1 comprises the steps of:
providing the at one selectable educational accommodation as a plurality of selectable educational accommodations;
displaying a grid of entry boxes with the corresponding educator PC device of the arbitrary educator account during step (D), wherein each column in the grid of entry boxes is associated with a corresponding accommodation from the plurality of selectable educational accommodations, and wherein each row in the grid of entry boxes is associated with a corresponding date; and
receiving the dated compliance entry in at least one specific entry box from the grid of entry boxes with the corresponding educator PC device of the arbitrary educator account after step (E), wherein the dated compliance entry is associated with the corresponding accommodation of the specific entry box, and wherein the dated compliance entry is associated with the corresponding date of the specific entry box.

3. The method of managing educational accommodations for students, the method as claimed in claim 1 comprises the steps of:
providing at least one administrator account managed by the remote server, wherein the administrator account is associated with a corresponding administrator PC device;
prompting the administrator account to view at least one specific student profile from the plurality of student profiles with the corresponding administrator PC device; and
displaying the specific student profile with the corresponding administrator PC device, if the specific student profile is selected to be viewed by the administrator account.

4. The method of managing educational accommodations for students, the method as claimed in claim 3 comprises the steps of:
providing the educational plan of the specific student profile with at least one related educational accommodation; and
further displaying the related education accommodation with the corresponding administrator PC device.

5. The method of managing educational accommodations for students, the method as claimed in claim 4 comprises the steps of:
providing the related educational accommodation with at least one related dated compliance entry; and
further displaying the related dated compliance entry with the corresponding administrator PC device.

6. The method of managing educational accommodations for students, the method as claimed in claim 1 comprises the steps of:
providing at least one administrator account managed by the remote server, wherein the administrator account is associated with a corresponding administrator PC device;
providing a plurality of educational groups managed by the remote server, wherein the plurality of educator accounts and the plurality of student profiles are organized into the plurality of educational groups;
prompting the administrator account to view at least one specific educational group from the plurality of educational groups with the corresponding administrator PC device; and
displaying the specific educational group with the corresponding administrator PC device, if the specific educational group is selected to be viewed by the administrator account.

7. The method of managing educational accommodations for students, the method as claimed in claim 6, wherein each educational group is selected from a group consisting of: a class, a school, and a schooling district.

8. The method of managing educational accommodations for students, the method as claimed in claim 6 comprises the steps of:
prompting the administrator account to reassign at least one specific educator account to at least one desired educational group with the corresponding administrator PC device, wherein the specific educator account is from the plurality of educator accounts, and wherein the desired educational group is from the plurality of educational groups; and
organizing the specific educator account into the desired educational group with the remote server, if the specific educator account is selected to be reassigned to the desired educational group by the administrator account.

9. The method of managing educational accommodations for students, the method as claimed in claim 6 comprises the steps of:
prompting the administrator account to reassign at least one specific student profile to at least one desired educational group with the corresponding administrator PC device, wherein the specific student profile is from the plurality of student profiles, and wherein the desired educational group is from the plurality of educational groups; and
organizing the specific student profile into the desired educational group with the remote server, if the specific student profile is selected to be reassigned to the desired educational group by the administrator account.

10. The method of managing educational accommodations for students, the method as claimed in claim 1 comprises the steps of:
providing at least one administrator account managed by the remote server, wherein the administrator account is associated with a corresponding administrator PC device;
prompting the administrator account to add at least one new educational accommodation to the educational plan of at least one specific student profile with the corresponding administrator PC device, wherein the specific student profile is from the plurality of student profiles; and
appending the new educational accommodation into the educational plan of the specific student profile with the remote server, if the new educational accommodation is selected to be added to the educational plan of the specific student profile by the administrator account.

11. The method of managing educational accommodations for students, the method as claimed in claim 1 comprises the steps of:
prompting the arbitrary educator account to verify the dated compliance entry for the selectable educational accommodation before step (G); and
executing step (G), if at least one validating action in relation to the dated compliance entry for the selectable educational accommodation is executed by the arbitrary educator account.
